(19) United States
(12) Patent Application Publication
(10) Pub. No.: US 2024/0423761 A1
(43) Pub. Date: Dec. 26, 2024

(54) INDIRECT ORTHODONTIC BONDING SYSTEMS AND METHODS

(71) Applicant: Swift Health Systems Inc., Irvine, CA (US)

(72) Inventors: Monica Y. Suh, Irvine, CA (US); Shreya Akkenapally, Irvine, CA (US); Scott C. Schwartz, Irvine, CA (US); Duy M. Do, Irvine, CA (US); Allen Huynh, Irvine, CA (US)

(21) Appl. No.: 18/777,177

(22) Filed: Jul. 18, 2024

Related U.S. Application Data
(63) Continuation of application No. 17/084,383, filed on Oct. 29, 2020, now Pat. No. 12,053,346.
(60) Provisional application No. 62/928,587, filed on Oct. 31, 2019.

(51) Int. Cl. A61C 7/14; A61C 9/00; B29C 64/393; B29L 31/00; B33Y 50/02; B33Y 80/00

(52) U.S. Cl. CPC A61C 7/146; A61C 9/004; B29C 64/393; B33Y 50/02; B33Y 80/00; B29L 2031/753

(57) ABSTRACT

Systems and methods for fabricating indirect bonding trays are disclosed. Digital models of a patient's teeth can be created with digital brackets positioned on the digital model of a patient's teeth. Digital models of indirect bonding trays can be created to retain and transfer the brackets. The indirect bonding trays can be 3-D printed with wells that the functional brackets can be placed into and thereafter transferred to the patient. The 3-D printed indirect bonding tray can comprise two resins, with one resin forming the tray and another resin forming a functional feature.

### INCORPORATION BY REFERENCE

This application is a continuation of U.S. application Ser. No. 17/084,383, filed Oct. 29, 2020, which claims the priority benefit of U.S. Provisional Application No. 62/928,587, filed Oct. 31, 2019, each of which are hereby incorporated by reference in their entireties herein. Any and all applications for which a foreign or domestic priority claim is identified in the Application Data Sheet as filed with the present application are hereby incorporated by reference under 37 CFR 1.57.

### BACKGROUND

### Field

This disclosure relates, in some aspects, to improved indirect bonding systems and methods for orthodontic bracket placement. The indirect bonding systems can improve bracket positioning with a number of features to advance the ease of use and minimize errors during bracket delivery.

### SUMMARY

In some embodiments, disclosed herein are methods for fabricating an indirect bonding tray for placement of orthodontic brackets. The methods can involve, for example, providing a digitally defined orthodontic bracket setup, wherein digital brackets are positioned on a digital model of a patient's teeth. The method may include directly printing a 3-D printed indirect bonding tray, wherein multiple resin materials are used in the 3-D printed indirect bonding tray. The 3-D printed indirect bonding tray can include at least one well corresponding to at least one functional orthodontic bracket. In some embodiments, the indirect bonding tray need not necessarily be 3-D printed and can be created through other mechanisms.

The method can include modifying at least one parameter of the digital brackets in the digitally defined orthodontic bracket setup. In some embodiments, a functional orthodontic bracket is secured within each well of the 3-D printed indirect bonding tray. In some embodiments, the 3-D printed indirect bonding tray comprises a plurality of wells corresponding to a plurality of functional brackets. In some embodiments, the digitally defined orthodontic bracket setup and fabrication of the 3-D printed indirect bonding tray are performed at remote locations from each other. The method can include digitally moving the teeth from positions of malocclusion to positions of ideal occlusion. The method can include positioning digital brackets on surfaces of the teeth while in positions of malocclusion and moving the teeth to positions of ideal occlusion (e.g., a second position which may be an intermediate position between an initial position and a finalized position) while maintaining the positioning of the digital brackets on the surfaces of the teeth. In some embodiments, the 3-D printed indirect bonding tray comprises two separate 3-D printed resin materials. In some embodiments, the 3-D printed indirect bonding tray comprises a first resin material for the tray. In some embodiments, the 3-D printed indirect bonding tray comprises a second resin material for one or more tray markings. In some embodiments, the 3-D printed indirect bonding tray comprises a second resin material for one or more handles. In some embodiments, the 3-D printed indirect bonding tray comprises a second resin material encapsulated within a first resin material. In some embodiments, the 3-D printed indirect bonding tray comprises at least one biocompatible resin. In some embodiments, the 3-D printed indirect bonding tray comprises a midline marking. In some embodiments, the 3-D printed indirect bonding tray comprises an alphanumeric tooth marking. In some embodiments, the 3-D printed indirect bonding tray comprises a rigid handle.

Also disclosed herein, in some embodiments, are methods for placing orthodontic brackets onto teeth. The method can include providing an indirect bonding tray comprising wells comprising one or more functional orthodontic brackets, wherein the indirect bonding tray comprises two resin materials, wherein the indirect bonding tray is rapidly prototyped. In some embodiments, the method may include positioning the indirect bonding tray in contact with a patient's teeth. In some embodiments, the method may include transferring the functional orthodontic brackets from the indirect bonding tray to the patient's teeth. In some embodiments, the method may include printing instructive information to the indirect bonding tray.

Also disclosed herein are systems for use in fabricating an indirect bonding tray for placement of orthodontic brackets. The system can include a digital model of a patient's teeth. The system can include an indirect bonding tray comprising wells configured to contain one or more functional orthodontic brackets, wherein the indirect bonding tray comprises two resin materials. In some embodiments, the indirect bonding tray is digitally designed and customized per patient.

In some embodiments, a system can comprise, consist essentially of, or consist of any number of features disclosed herein.

In some embodiments, a method can comprise, consist essentially of, or consist of any number of features disclosed herein.

Further features and advantages of various embodiments contemplated by the present disclosure are described in detail below with reference to the accompanying drawings.

### BRIEF DESCRIPTION OF THE DRAWINGS

These drawings are illustrative embodiments and do not present all possible embodiments.

FIG. 1 illustrates a 3-D printed indirect bonding tray of the maxillary arch, according to some embodiments.

FIG. 2 illustrates another view of a 3-D printed indirect bonding tray of the maxillary arch of FIG. 1.

FIG. 3 illustrates a 3-D printed indirect bonding tray of the mandibular arch, according to some embodiments.

FIG. 4 illustrates another view of a 3-D printed indirect bonding tray of the mandibular arch of FIG. 3.

FIGS. 5A-5C illustrate 3-D printed indirect bonding trays, according to some embodiments.

FIGS. 6A-6F illustrate a 3-D printed indirect bonding tray of an upper arch of FIGS. 5A-5C.

FIGS. 7A-7F illustrate a 3-D printed indirect bonding tray of a lower arch of FIGS. 5A-5C.

FIGS. 8A-8C illustrate the 3-D printed bonding trays of FIGS. 5A-5C without tabs, according to some embodiments.

FIGS. 9A-9C illustrate the 3-D printed bonding trays of FIGS. 6A-6C without tabs, and FIGS. 9D and 9E illustrate the 3-D printed bonding trays of FIGS. 6E and 6F, respectively, without tabs.

FIGS. 10A-10C illustrate the 3-D printed bonding trays of FIGS. 7A-7C without tabs, and FIGS. 10D and 10E illustrate the 3-D printed bonding trays of FIGS. 7E and 7F, respectively, without tabs.

### DETAILED DESCRIPTION

Indirect bonding (IDB) trays have been used in orthodontics to transfer the planned position of brackets from a model to a patient's teeth. This has traditionally been done by placing the functional brackets on a physical model (e.g., outside of the patient) and then transferring the brackets to the patient through an indirect bonding transfer tray technique.

Recently, the process of positioning brackets on teeth has been improved by digitally planning the position of brackets on a computer. This digital position of the bracket is then transferred to the patient through several methods. However, there are often drawbacks to the current methods of manufacturing indirect bonding trays. For instance, the material for forming an indirect bonding tray may not be well-suited for precision fabrication of intricate geometries directly from a digital model. As another example, there are often times human error in production such as placeholder bracket placement, which would propagate onto the indirect bonding tray and then to the patient. Improved systems and methods are needed.

In some embodiments, disclosed herein are improved systems and methods of creating indirect bonding trays. This method can use in some cases digital planning to place brackets in their correct position. The method can in some cases utilize a 3-D printed indirect bonding tray. The method can in some cases use biocompatible photopolymer resins to 3-D print an indirect bonding tray with features that facilitate bonding of orthodontic brackets for orthodontic treatment. The 3-D printed indirect bonding tray can advantageously improve manufacturability, and may lead to a throughput increase. The 3-D printed indirect bonding tray can improve bonding accuracy to a digitally pre-defined orthodontic bracket setup. The 3-D printed indirect bonding tray can have ease of identification and clinical application. The 3-D printed indirect bonding tray can have an improved aesthetic appearance. The 3-D printed indirect bonding tray can reduce variation in part appearance.

In some embodiments, disclosed herein are improvements on indirect bonding methods that utilize a moldable material over at least one non-functional placeholder orthodontic bracket attached to a tooth of the physical model. The moldable material can be a polyvinyl siloxane (PVS) material, which is used to mold over a 3-D printed model to capture bracket position. This PVS mold can form the indirect bonding tray. In contrast, the disclosed methods can utilize a digitally pre-defined orthodontic bracket setup to directly 3-D print the indirect bonding tray using multiple resin materials. While other 3-D printing indirect bonding trays may utilize a single resin material, multiple (e.g., 2, 3, 4, 5, or more) resin materials are utilized in systems and methods as disclosed.

In some embodiments, trays are digitally designed and customized per patient for direct 3-D printing. Trays can be designed to be printed using two or more separate 3-D print resin materials. In some embodiments, one material is used for the tray and a second material, which can be a different material in one or more respects, such as a different colored material is used for the tray markings and handles. In some embodiments, tray marking material is encapsulated within tray material for biocompatibility and for mitigation of inadvertent marking removal during use. Trays can be marked with the following for ease of clinical application: key midline markings on the upper and lower anterior tray segments; and key individual alphanumeric teeth markings indicating region and tooth position on all tray segments. Trays are designed and printed with rigid handles for ease of grip during clinical application. In some embodiments, the outer surface of the tray is contoured to patient-specific anatomy resulting in minimal profile for improved patient comfort and ease of clinical application. In some embodiments, a detachable tab on each tray segment indicates patient case ID for patient identification during both internal production processes and clinical use. In some embodiments, a custom patient-specific identifier is on each tray segment to indicate a patient case ID or other information for patient identification, which can be used for identification during both internal production processes and clinical use.

During digital design and viewing the target occlusion, space for additional curable adhesive and/or composite material can be added to the indirect bonding tray model to create a bite turbo. Bite turbos are small composite platforms placed on the inside of the upper front teeth, or on the biting surfaces of the back molars, to prevent full closure of the teeth. In some embodiments, the bite turbos prevent brackets from colliding into each other when a patient bites down. The bite turbos can be directional bite turbos in some cases.

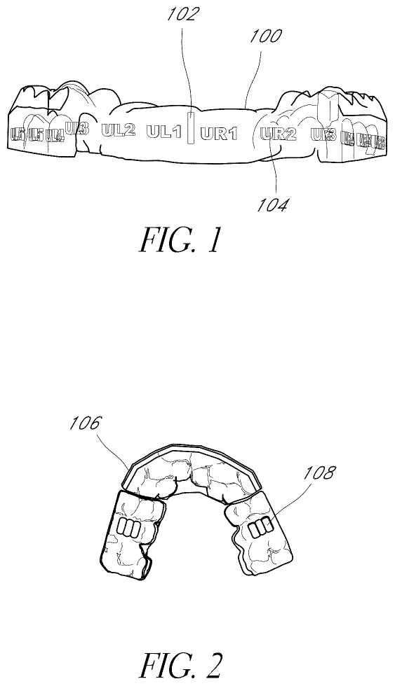

FIGS. 1 and 2 schematically illustrate a 3-D printed indirect bonding tray 100 of the maxillary arch. FIG. 1 illustrates a side view of the 3-D printed indirect bonding tray 100 and FIG. 2 illustrates a top view of the 3-D printed indirect bonding tray 100. FIG. 1 illustrates a key midline marking 102. FIG. 1 illustrates a key individual teeth markings 104. FIG. 2 illustrates that the 3-D printed indirect bonding tray 100 comprises an outer surface 106. The outer surface 106 can be contoured to the patient-specific anatomy. FIG. 2 illustrates rigid handles 108 for each of clinical application.

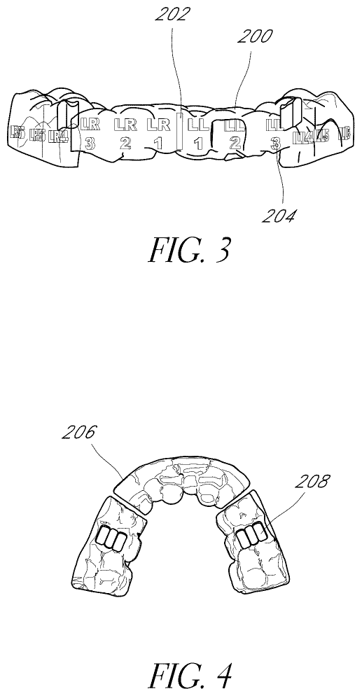

FIGS. 3 and 4 schematically illustrate a 3-D printed indirect bonding tray 200 of the mandibular arch. FIG. 3 illustrates a side view of the 3-D printed indirect bonding tray 200 and FIG. 4 illustrates a top view of the 3-D printed indirect bonding tray 200. FIG. 3 illustrates a key midline marking 202. FIG. 3 illustrates a key individual teeth markings 204. FIG. 4 illustrates that the 3-D printed indirect bonding tray 200 comprises an outer surface 206. The outer surface 206 can be contoured to the patient-specific anatomy. FIG. 4 illustrates rigid handles 208 for each of clinical application.

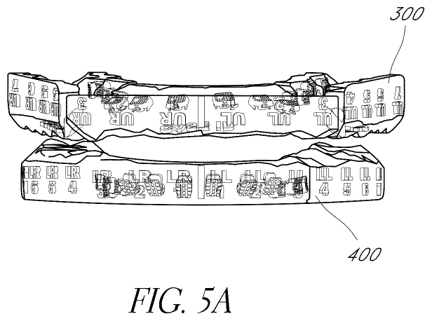

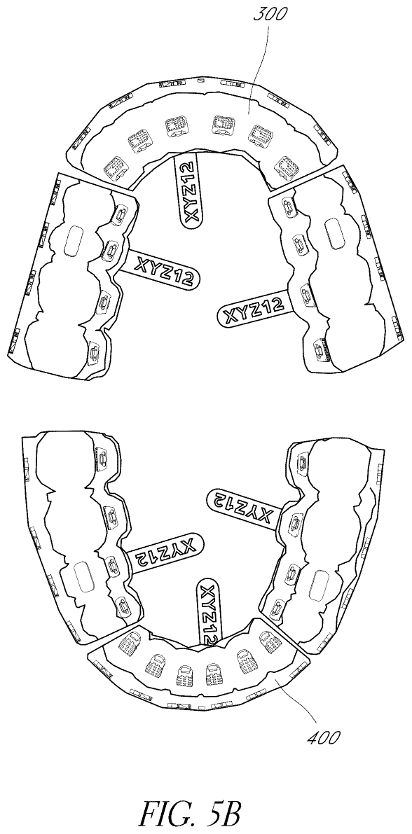

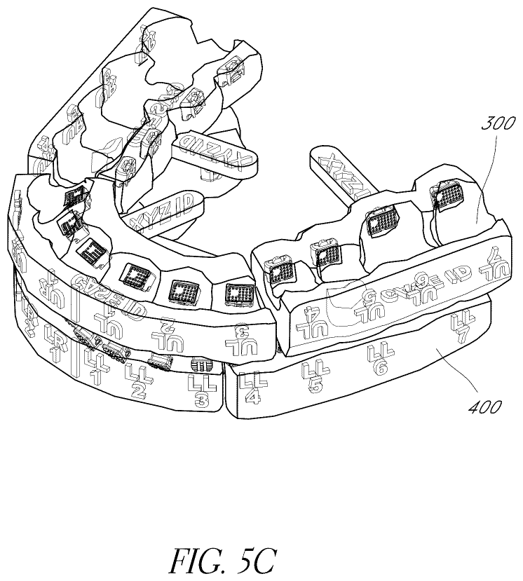

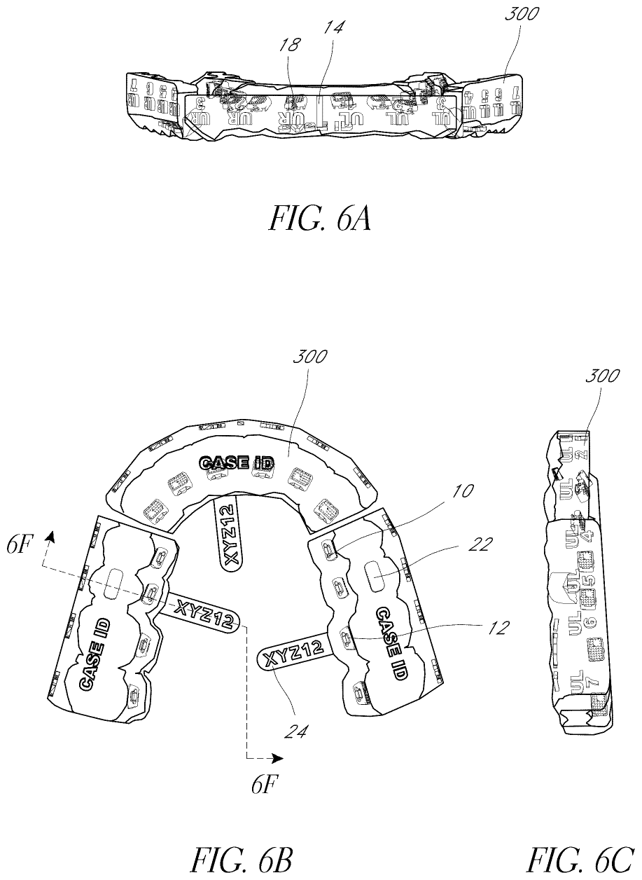

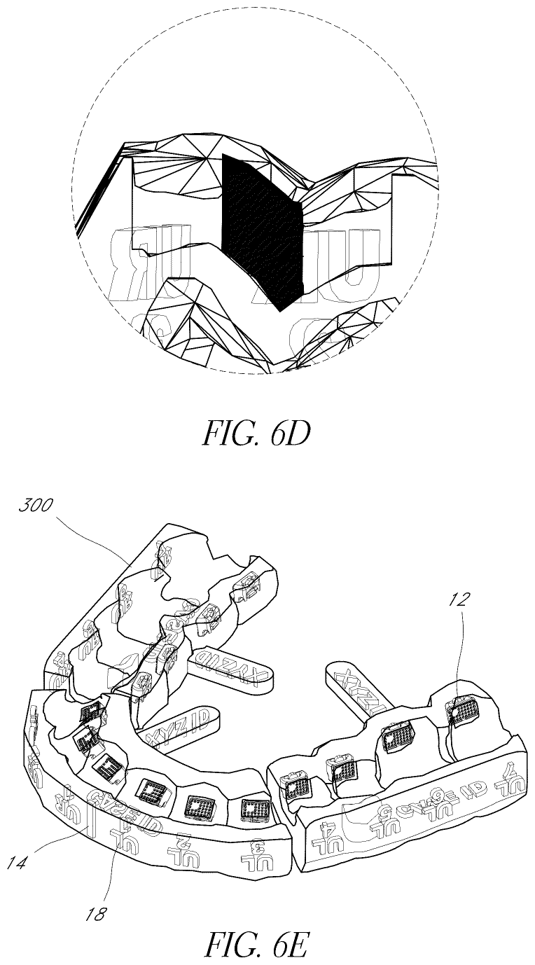

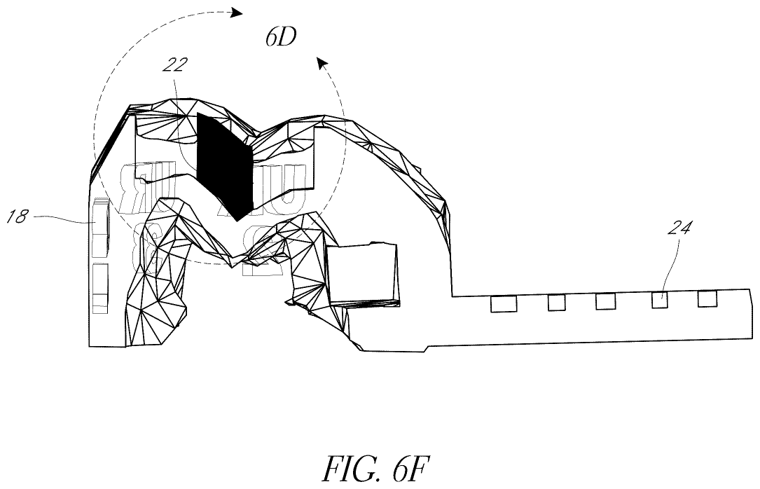

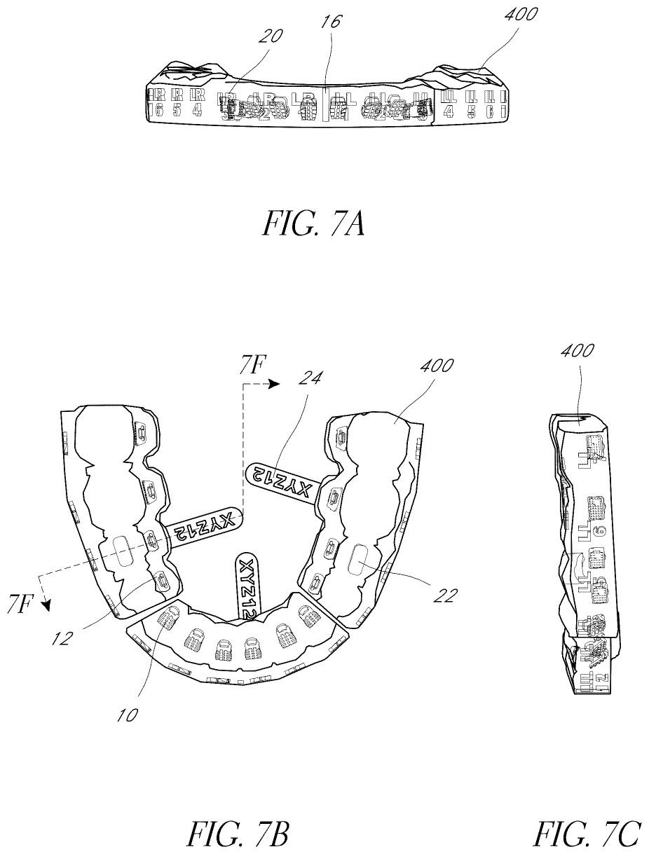

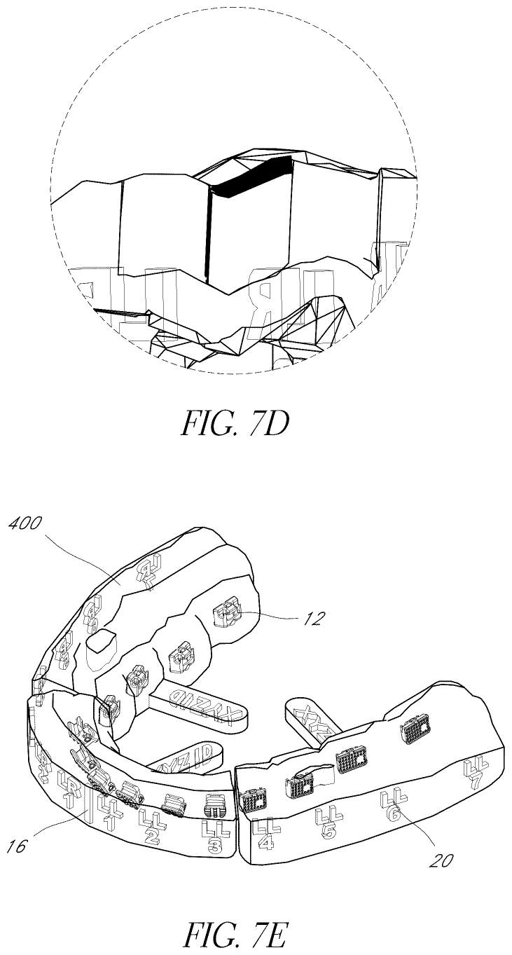

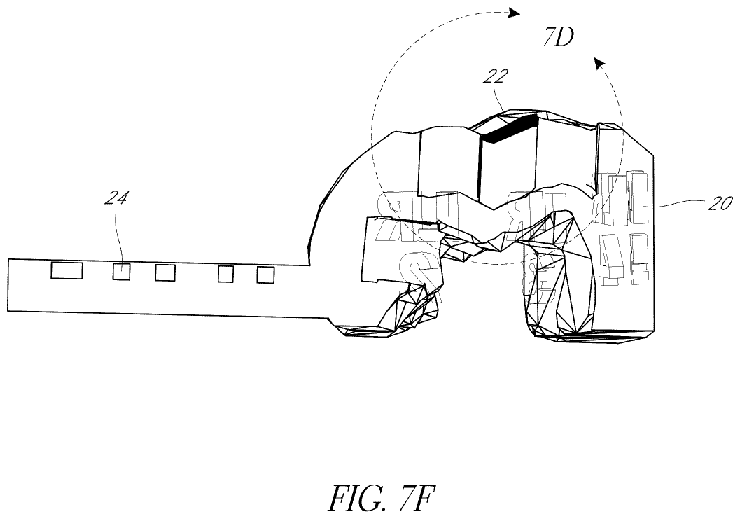

FIGS. 5A-5C illustrate 3-D printed indirect bonding trays 300 and 400, according to some embodiments. FIGS. 6A-6F illustrate the 3-D printed indirect bonding tray 300. FIGS. 7A-7F illustrate the 3-D printed indirect bonding tray 400.

The 3-D printed indirect bonding trays are utilized in conjunction with brackets. The brackets have various external surfaces or geometries. Each bracket can correspond to a digital representation of a bracket, for instance in bracket placement software. The functional brackets can be placed in the same exact position, or substantially similar location, as the digital brackets. The outline of the bracket interface with the individual tooth may be preserved to ensure proper alignment of the functional bracket with the patient's tooth during transfer. The digital teeth and digital brackets of the ideal occlusion model may be moved back onto the malocclusion digital model. The digital bracket position relative to the tooth may be maintained as the teeth are repositioned from a state of ideal occlusion (e.g., a second position of occlusion different than a first position of malocclusion) back to original state of malocclusion (e.g., a first position of malocclusion). The digital brackets and the malocclusion digital model can be combined into a single file for each arch.

The 3-D printed indirect bonding tray can be modeled. Features such as handles or tabs may be added to the indirect bonding tray model to aid in rapid prototyping. The features can facilitate fabrication of the indirect bonding tray and/or handling of the indirect bonding tray. For instance, the features may provide structural support to the indirect bonding tray during fabrication. In some embodiments, digital perforations may be added between one or more teeth. These perforations would allow the clinician to snap off individual teeth or groups of teeth to make sectional indirect bonding (IDB) trays.

The lab may rapid prototype this indirect bonding tray that includes the malocclusion digital indirect bonding tray configured to couple with functional brackets. Alternatively, the lab may send the final digital indirect bonding tray to the doctor (e.g., electronically send via the internet) to allow direct fabrication by the doctor.

Fabrication of the indirect bonding tray may be performed by a rapid prototyping means, such as 3-D printing, or any other suitable means known in the art. In some embodiments, the physical model may comprise the entire set, or only a subset of the patient's teeth. The subset of teeth may correspond to a segment of the dental arch. The indirect bonding tray may correspond in size (e.g., the length the tray extends along the dental arch) to the segment of the dental arch or may correspond to the entire arch but may not include teeth not selected as part of the subset.

FIGS. 5A-7F depict indirect bonding trays for 3-D printing. The brackets 10, 12 may be coupled to the indirect bonding tray prior to placement on the patient. The brackets 10, 12 can have different sizes or shapes dictated, at least in part, by the digital model of the bracket placement and the anatomy of the teeth.

The methods can utilize a digitally pre-defined orthodontic bracket setup to directly 3-D print the indirect bonding tray using multiple resin materials. In some methods, images of teeth may be obtained by using a digital intra-oral scanner, a cone-beam computed tomography (CBCT) X-ray scanner, or by taking polyvinyl siloxane (PVS) impressions, followed by pouring of study models and scanning of the study model. Digital images of teeth can be rendered in imaging software where each tooth image can be segmented from the whole dental arch image and then re-arranged in an expected alignment, a process known as virtual set-up of teeth.

In some methods, orthodontic bracket images may be digitally placed onto teeth in locations that fit the preference of the user. Bases of orthodontic brackets may be custom designed with the tooth side of the bases fitting perfectly to the tooth surfaces where orthodontic brackets are to be bonded, and the orthodontic bracket side of the bases may merge and connect with the base side of the orthodontic bracket. The virtual teeth set-up with the virtually designed orthodontic brackets may be sent to the user for approval and adjustments may be made according to the user's request. In some embodiments, the system includes a digital representation of a planned model comprising the patient's teeth and orthodontic brackets positioned on the patient's teeth in planned positions for orthodontic treatment.

Digital models of the indirect bonding trays can be rendered in imaging software where each indirect bonding tray can span the whole dental arch or can be segmented from the whole dental arch. The digital model of the indirect bonding tray can include one or more spaces or wells for accommodating the orthodontic brackets to be transferred to the patient's teeth. The one or more spaces or wells accept functional brackets that are transferred from the indirect bonding tray to the tooth. The digital model of the indirect bonding trays can be manufactured by any technique including 3-D printing. In some methods, indirect bonding trays can be manufactured from the digital model using casting, metal injection molding, 3-D printing, micromachining, any combination of generic mass production and customization techniques, and/or any direct digital manufacturing technique

The 3-D printing process builds a 3-D object, typically by successively adding dots or layers of material. The 3-D printing process relies on a digital model, such as a CAD model or other digital medium, to provide instructions for the printing. The 3-D printing process allows for the production of complex shapes or geometries, such as the intricate wells of the indirect bonding trays. The 3-D printing process can also be referred to as additive manufacturing, since material is successively added to build the object. The 3-D printing process can encompass any technique known in the art, including fused deposition modeling (FDM) and fused particle fabrication (FPF). In some methods, the indirect bonding trays are fabricated using additive manufacturing techniques such as stereolithography (SLA or SL).

Conventional 3-D printing utilizes a single resin material. As described herein, multi-material printing allows the trays to advantageously be compositions of two or more resins. The trays can comprise heterogeneous mixtures of materials, such that each resin is separate or independent. In some embodiments, the indirect bonding tray does not contain a single resin. The indirect bonding tray is not homogenous in material in some cases. In some embodiments, the indirect bonding tray includes two or more separate and distinct resins. The two or more resins can include different colors or other visually distinct identifiers. The two or more resins can be visually identical. The two or more resins can have different material properties. The two or more resins can have the same material properties. The two or more resins can have different toughness or strength. The two or more resins can have different flexibilities or elasticities. The two or more resins can have separate and distinct locations within the indirect bonding tray. The two or more resins can have separate and distinct functions relating to the indirect bonding tray.

The 3-D printed indirect bonding tray can be comprised of various materials of different durometers and colors. Different durometers allows the creation of an indirect bonding tray that is sufficiently compliant to get around the teeth and seat properly. Different durometers allows the creation of an indirect bonding tray with added firmer segments that can serve specific purposes, such as an integrated handle that can be grasped by forceps for proper placement/seating. Different durometers can be used to reinforce segments that require additional stiffness. Different colors allow the creation of an indirect bonding tray that permits the addition of color marking for indicators of tooth position and proper placement of indirect bonding tray.

Trays are digitally designed and customized per patient for direct 3-D printing. Indirect bonding trays can be custom shaped to fit one or more of an individual patient's teeth. Indirect bonding trays may be custom made to fit to a particular patient's particular tooth or teeth. In some embodiments, portions of the indirect bonding tray may be made to fit a certain type of teeth for all patients. In some embodiments, portions of the indirect bonding tray may be made to fit all teeth indiscriminately. Indirect bonding trays may be custom designed with the tooth side of the tray fitting perfectly to the tooth surfaces where orthodontic brackets are to be bonded. Indirect bonding trays may be used to position the orthodontic bracket correctly to the tooth surface during bonding or rebonding of orthodontic brackets clinically.

Trays are designed to be printed using two separate 3-D print resin materials. The 3-D printed indirect bonding tray can be formed from any resin material. The resin material is dispensed by a 3-D printer (e.g, in droplets) according to an indirect bonding tray digital model. The resin materials can be utilized in any rapid prototype procedure, including 3-D printing. In some embodiments, the resin is photo-cured with UV light. Any other suitable application means may be used as well. The 3-D print resin materials are designed to be printed to cover the wells for the functional brackets and all or selected surfaces of the teeth. The 3-D print resin can be applied in layers or in a progressive manner to build the indirect bonding tray. The 3-D printing can create the wells that the orthodontic brackets 10, 12 can be placed into on the indirect bonding tray. In embodiments where the indirect bonding tray comprises only a segment of the patient's dental arch, the 3-D printer may form only that segment without completing the entire arch. Partial indirect bonding trays may be useful for performing bracket replacements and/or for subsequent placement of brackets that were initially infeasible to place for instance, due to physical interference such as overcrowding.

In some embodiments, two resin materials are utilized for the indirect bonding trays. One material is used for the tray. This first resin can have characteristics suited for the creation of the wells. This first resin can have characteristics suited for the retention of the functional brackets. This first resin can have characteristics suited for precisely locating the bracket relative to the tooth surface. Another material is used for another portion of the indirect bonding tray. This second resin can be used for the tray markings. This second resin can be used for the handles. This second resin can be used for any secondary function, such as to facilitate placement of the tray. This second resin can have a different color, for instance the first resin can be clear and the second resin can be colored or opaque. The first resin can form the tray. The tray can be made of translucent materials allowing curing of UV/light curable adhesives for the brackets. This second resin can have a different flexibility, for instance the first resin can be more flexible and the second resin can be more rigid. This second resin can have a different bending strength, for instance the first resin can be more bendable or flexible and the second resin can be more rigid.

In some embodiments, one material encapsulates another material. The first resin can encapsulate the second resin. The first resin can contact the patient and therefore be biocompatible. The second resin can be encapsulated such that the second resin need not be biocompatible. In some embodiments, the second resin need not be biocompatible so long as the second reside does not leach out into the first resin. In some embodiments, the tray marking material is encapsulated within tray material. The encapsulation can be for biocompatibility. In some methods and systems, non-biocompatible materials are used in an indirect bonding tray, by surrounding the non-biocompatible materials with biocompatible materials. There are opportunities for material properties for an indirect bonding tray that are not available in biocompatible materials. For example, an additive manufacturing process can include more than one material for labelling information directly embedded within the indirect bonding tray. In these methods, the indirect bonding tray can be designed to encapsulate the non-biocompatible material entirely by biocompatible materials. The encapsulation can also mitigate inadvertent marking removal during use. For instance, the encapsulation prevents removal of the key markings that help with placement.

Trays can including markings for ease of clinical application. In some embodiments, the 3-D printed indirect bonding tray may comprise indicia, including instructional information printed or otherwise marked on the 3-D printed indirect bonding tray. The information may comprise, for example, identification markers that include, for instance, information relevant to placing the proper tray in the proper location on the correct patient's teeth (e.g., tooth number position, upper or lower arch indicator, patient number, etc.). In some cases, the information may be 3-D printed onto the indirect bonding tray. For example, the 3-D printed indirect bonding tray may be modified with a relief, embossment, stamp, indentation, etc. of text or other markings indicative of the information. The information may be positioned, for example, in or onto a tooth well such that it can be seen even after placement of the functional orthodontic brackets 10, 12. The information may be sized (e.g., in area and/or depth) such that it does not significantly alter negative impression and, therefore, does not interfere with the proper fitting of the 3-D printed indirect bonding tray to the patient's teeth. In some cases, the corresponding wells of the 3-D printed indirect bonding tray may be colored (e.g., with an agent, ink, or paint) to make the information more readily visible. For example, the colored agent, ink, or paint may fill an indentation in the 3-D printed indirect bonding tray before drying such that it makes the information stand out. Residual agent, ink, or dye may be wiped clean from the surface of the 3-D printed indirect bonding tray. Additionally or alternatively, information may be transferred to an external surface of the indirect bonding tray by mating the 3-D printed indirect bonding tray with an additional tray which marks the 3-D printed indirect bonding tray. In some embodiments, the information may be directly transferred onto the 3-D printed indirect bonding tray once mated, such as a stamp. For example, the information may be written on the additional tray or a marker comprising the information may be attached to the additional tray. In some embodiments, the information may be in non-textual form. For example, the information may be a color or fiduciary marker. In some embodiments, the information can be contained within a barcode, passive or active RFID tag, or other elements that can be positioned in various locations similar to the indicia noted above.

The markings can include any markings to facilitate placement. As one example, key midline markings 14, 16 can be provided on the upper and lower anterior tray segments. The midline markings 14, 16 can be lines located on or within the 3-D printed indirect bonding tray. The lines can be solid or discontinuous, such as dashed. The upper and lower trays can include the same midline markings 14, 16, or the midline markings 14, 16 can be different for each tray. The midline markings 14, 16 can be a different color than the first resin forming the tray. The midline markings 14, 16 can comprise the second resin. The midline markings 14, 16 can be encapsulated within the first resin.

Key individual alphanumeric teeth markings can indicate region and tooth position on all tray segments. As another example, key alphanumeric teeth markings 18, 20 can be provided on the upper and lower anterior tray segments. The teeth markings 18, 20 can be numbers, letters, and/or symbols located on or within the 3-D printed indirect bonding tray. The teeth markings 18, 20 can correspond to industry accepted teeth identifications. The upper and lower trays can include the same format for teeth markings 18, 20, or the teeth markings 18, 20 can be a different format for each tray. In the illustrated example, the alphanumeric teeth markings include letters indicating the tray and numbers indicating the tooth, separated by a line. Other configurations of indicia are contemplated. The alphanumeric teeth markings 18, 20 can be a different color than the first resin forming the tray. The alphanumeric teeth markings 18, 20 can comprise the second resin. The alphanumeric teeth markings 18, 20 can be encapsulated within the first resin. FIGS. 6D, 6F, 7D, and 7F illustrate the positioning of the teeth markings 18, 20. The teeth markings 18, 20 can be positioned between the well for the tooth and the inside of the cheek.

Trays can be designed and printed with rigid handles for ease of grip during clinical application. As yet another example, key handles 22 can be provided on the upper and lower anterior tray segments. The handles 22 can be positioned on any surface of the tray. In the illustrated example, handles are positioned on the occlusal surface of the tooth. This position allows direct application of an upward or downward force in order to seat the 3-D printed indirect bonding tray against the surface of the teeth. The handles 22 can extend from any exterior surface of the main portion of the indirect bonding tray. In the illustrated example, two or more tray segments can include a handle 22. Other configurations of handles are contemplated, including any number of handles and any orientation of handles. The handles 22 can include the second resin. The handles 22 can be a different color than the first resin forming the tray. The handles 22 can be a different material than the first resin forming the tray, for instance the second resin forming the handles can be stronger than the first resin. The handles can be rigid, or at least more rigid than another portion of the tray. FIGS. 6D, 6F, 7D, and 7F illustrate the positioning of the handle 22. The handle 22 can be positioned over a well for the tooth, spaced apart from the occlusal surface of the tooth.

The outer surface of the tray can be contoured to patient-specific anatomy resulting in minimal profile for improved patient comfort and ease of clinical application. The 3-D printed indirect bonding tray can be shaped to avoid patient discomfort. The portion of the 3-D printed indirect bonding tray facing the gums can be minimized. The 3-D printed indirect bonding tray remains in place for a short duration, only for bracket placement. However, the digital model can be designed to closely fit the patient, for patient comfort during the duration of the procedure. A minimized profile also can reduce resin material, leading to more rapid production and a lower costs. The 3-D printed indirect bonding tray can include rounded or atraumatic ends or edges so as to avoid causing pain or discomfort to the patient during any transient contact with oral tissue of the patient's mouth.

Detachable tabs 24 on each tray segment can indicate patient case identification for patient identification during both internal production processes and clinical use. As yet another example, key tabs 24 can be provided on the upper and lower anterior tray segments. The tabs 24 can include alphanumeric labeling to identify the patient. The tabs 24 can extend from an exterior surface of the main portion of the indirect bonding tray. In the illustrated example, each tray can include three tabs 24, located opposite of the gums of the patient, corresponding to the number of segments of the tray. In some embodiments, each segment includes a tab 24. Other configurations of tabs 24 are contemplated, including any number of tabs 24 and any orientation of tabs 24. The tabs 24 can include the first resin, and provide an extension of the main portion of the indirect bonding tray. The tabs 24 can include the second resin, for instance for alphanumeric markings. The alphanumeric markings can be a different color than the first resin forming the tray. The tabs 24 can be detached by the clinician prior to use with a patient to facilitate comfort. The tabs 24 can be detached after verifying that the 3-D printed indirect bonding tray corresponds to the patient to be treated. The tabs 24 can be used to verify that each segment has the same patient identification. In some embodiments, the tabs 24 are not detachable. FIGS. 6D, 6F, 7D, and 7F illustrate the positioning of the tab 24. The tab 24 can be positioned inward from a well for the tooth, spaced apart from the lingual surface of the tooth.

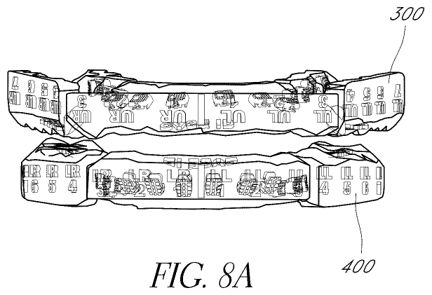

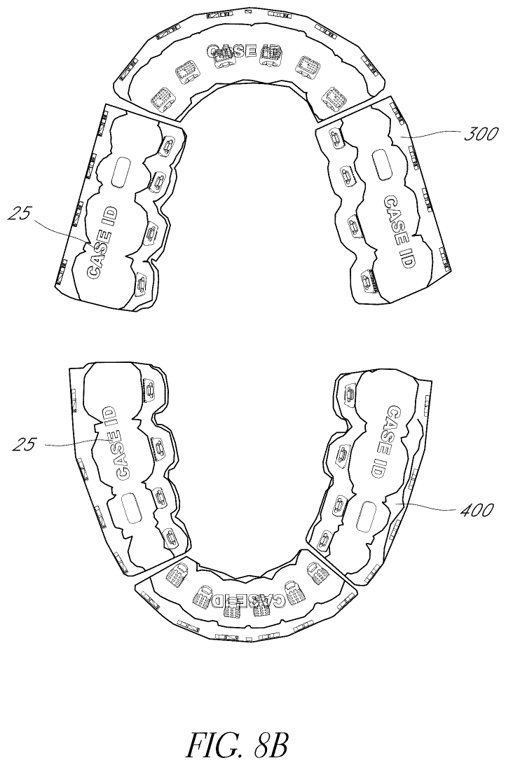

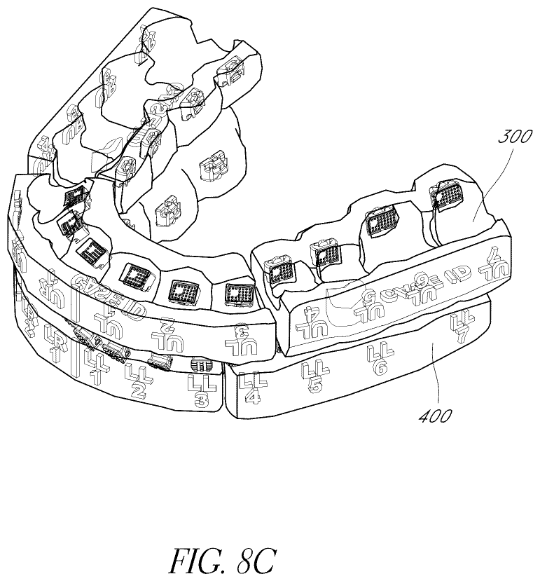

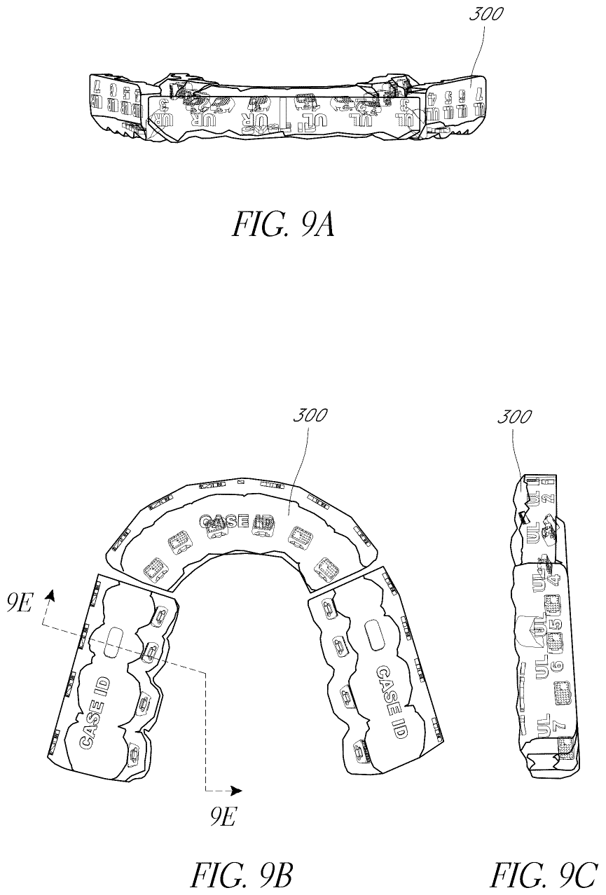

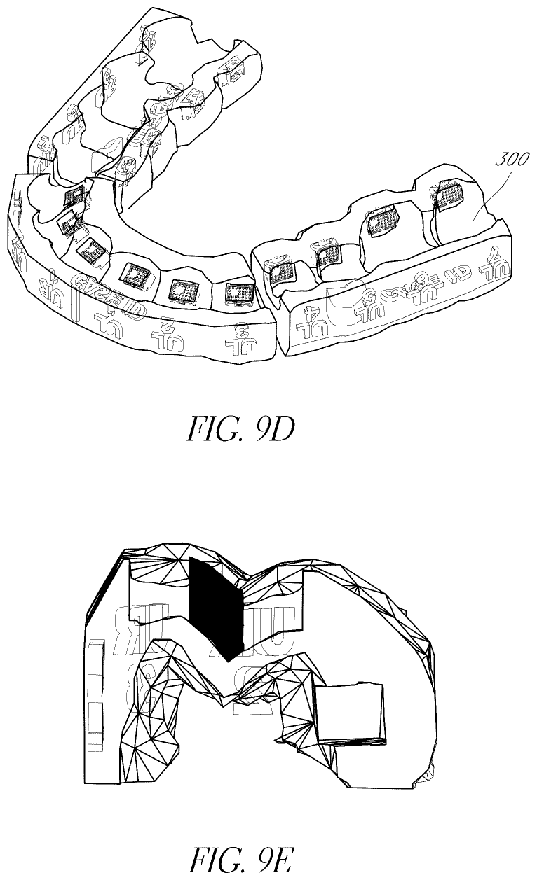

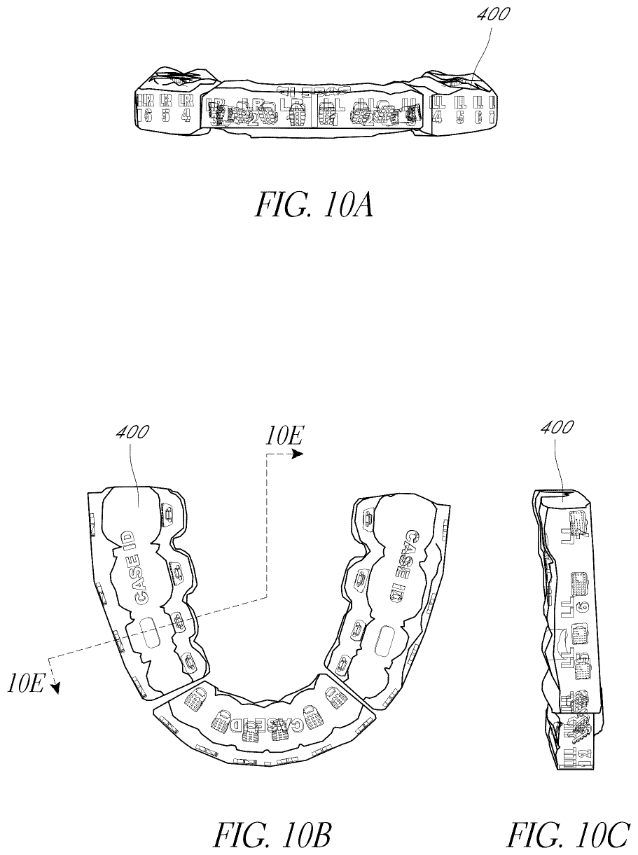

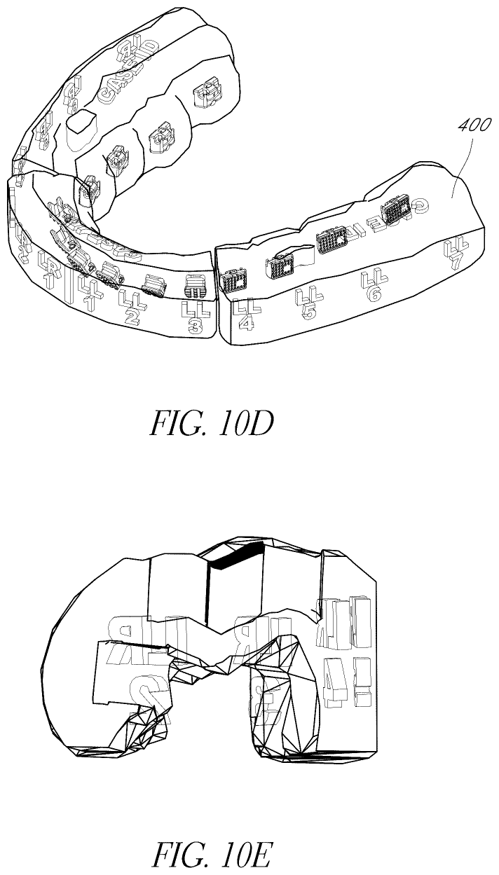

In some embodiments, as illustrated in FIGS. 8A-10E a custom patient-specific identifier 25 is on each tray segment instead of including tabs 24 to indicate a patient case ID or other information for patient identification, which can be used for identification during both internal production processes and clinical use. The patient-specific identifier 25 can include alphanumeric labeling to identify the patient. In the illustrated example, each tray includes three patient-specific identifiers 25. In the illustrated example, each segment includes a patient-specific identifier 25. Other configurations are contemplated in which any number of patient-specific identifiers 25 are positioned on any surface of the tray segment. In the illustrated example, the patient-specific identifier 25 is positioned on the occlusal surface of the tray. The patient-specific identifier 25 can be a different color than the first resin forming the tray. In some embodiments, tabs 24 and patient-specific identifiers 25 are used together.

Any added features may be removed from the rapid prototyped indirect bonding tray as necessary. The features may be fabricated (e.g., with reduced cross sections) such that they allow easy and precise breakage of the feature from the remainder of the indirect bonding tray with application of a sufficient amount of manual force. The features can also be kept to be used as handles to hold the indirect bonding tray for later processes.

For rebonding specific brackets in case of debond, it may be preferential to have an indirect bonding tray segment for just one tooth in order to get accurate placement. Traditionally, this has been accomplished by sectioning the indirect bonding tray with a sharp cutting tool. In some embodiments, the indirect bonding tray design includes snappable segments between all, or some subset of teeth to allow the indirect bonding tray to be broken consistently into smaller segments. During the digital design of the indirect bonding tray, break lines and/or perforations are added through a cross section of the indirect bonding tray materials making it easy to snap off in defined segments. This could also be achieved by perforating with another technology such as lasers.

The 3-D printed indirect bonding tray can include many advantages over other trays. The 3-D printed indirect bonding tray can improve manufacturability. The tray can be precisely designed from a digital model to retain functional brackets. The 3-D printed indirect bonding tray can improve tolerances between the well and the bracket. Based on the process utilized, the 3-D printed indirect bonding tray can lead to a throughput increase. The manufacturing occurs independent of human skill, rather, the throughput is dependent on the number of 3-D printers and runtime. The 3-D printed indirect bonding trays can be mass-produced by simply scaling the productivity of the printers. The 3-D printed indirect bonding tray can improve bonding accuracy to a digitally pre-defined orthodontic bracket setup. The tray is mechanically produced to a higher level of accuracy than typically achievable by other techniques. In some embodiments, the 3-D printed indirect bonding tray can meet tolerances of the digital model +/−0.005″ or +/−0.002″ per inch, whichever is greater.

The 3-D printed indirect bonding tray comprises two resins, wherein each resin can be specifically designed for a function such as marking or handling. The 3-D printed indirect bonding tray allows ease of identification of the patient. The 3-D printed indirect bonding tray allows ease of identification of each segment of the tray. The 3-D printed indirect bonding tray allows ease of identification for each tooth relative to the tray. The markings can be encapsulated and easily visualized through the first resin. The two resin format can also improve the aesthetic appearance of the 3-D printed indirect bonding tray. The markings can be clear and crisp, having the level of precision of the printer. The handles can be symmetrically formed and properly placed to facilitate handling. The 3-D printed indirect bonding tray can be an intuitive and complete tool for the transfer of brackets. The 3-D printed indirect bonding tray reduces variation in part appearance in some embodiments. The 3-D printed indirect bonding trays, including subcomponents such as handles, tabs, and markings, can be digitally modeled and printed without manual human interference. These subcomponents can be consistent across trays. In some embodiments, the tray can be formed with interdental spaces, such that non-essential features/materials normally present in between the teeth are subtracted and thus not present on the 3-D printed indirect bonding tray. This can, in some cases, be advantageous to create an improved seal.

As described herein, the 3-D printed indirect bonding tray may include wells for fitting to a patient's teeth and wells for receiving one or more functional orthodontic brackets to be transferred to the patient's teeth. The wells of the teeth may merge with each other. Each dental arch may essentially form one large well or a plurality of wells larger than individual teeth. The wells for the brackets may also merge into the wells for the teeth. The wells for the brackets may be formed to match the external outline or geometry of the functional brackets based on the digital brackets. The bracket wells may cause the teeth wells to extend deeper into the printed material of the indirect bonding tray, such as in an occlusal and/or lingual direction. Although the brackets 10, 12 depicted herein are depicted as lingual orthodontic brackets, the methods and systems described herein may be equally applied to other arrangements of orthodontic devices, including buccal orthodontic brackets.

The lab or orthodontist may place the functional brackets 10, 12 securely inside the bracket wells in the indirect bonding tray with the bonding side of the brackets facing outward away from the printed material of the indirect bonding tray and toward the open well conformed to receive the patient's teeth.

Adhesives may be added on the bonding side of the 3-D printed indirect bonding tray. Adhesives may be added to the brackets 10, 12 after all the brackets are properly placed in the indirect bonding tray in some cases. The adhesives may be cured or partially cured prior to transferring the 3-D printed indirect bonding tray and/or during application of the 3-D printed indirect bonding tray to the patient's teeth. After allowing sufficient time for the functional brackets 10, 12 to securely bond to the patient's teeth, the 3-D printed indirect bonding tray may be removed from the patient's mouth leaving the functional brackets 10, 12 in place on the patient's teeth.

A problem with indirect bonding trays is managing the adhesive that is applied by the orthodontic practitioner to the brackets in the indirect bonding tray. If the indirect bonding tray and brackets are designed 100% flush with the face of the teeth to be bonded and if there is excess adhesive added, then there is no place for the adhesive to go and the adhesive can spread across the tooth surface or get trapped in the bracket spaces, known as flash. In some embodiments, the indirect bonding tray can include a flash release to channel away any excess materials when pressure is applied during the light curing and bonding process. The indirect bonding tray can be digitally designed with the flash release within the indirect bonding tray. The indirect bonding tray can be digitally designed with one or more channels that are positioned around the location of the bracket to allow the flow of adhesive if excess adhesive is applied, or too much pressure is applied to the indirect bonding tray during bonding.

A wide range of resin materials are available for the 3-D printed indirect bonding tray. The 3-D printer resin is typically a liquid solution. The solution can include different monomers and oligomers, as well as additives. The major chemical classes of materials include ABS plastic, PLA, HIPS, PETG, carbon fiber filled, ASA, polyamide (nylon), glass filed polyamide, epoxy resins, silver, titanium, stainless steel, bronze, brass, gold, steel, ceramics, wax, photopolymers, polycarbonate, TPE, thermoplastic polyurethane, and combinations thereof. The material of the different resins results in different material properties. In some embodiments, an opaque metal can be used for the indirect bonding tray with a chemically activated adhesive for the brackets instead of a UV/light curable adhesive given the light blocking quality of the opaque metal. In some embodiments, the resin material could include an acrylate or methacrylate resin. One example of a methacrylate monomer is the condensation product of bisphenol A and glycidyl methacrylate, 2,2′-bis [4-(3-methacryloxy-2-hydroxy propoxy)-phenyl]-propane (Bis-GMA). Alternatively, BisGMA may be synthesized from the diglycidyl ether of bisphenol A and methacrylic acid. Other examples of resinous materials include the ring-opening polymerization of epoxides. Epoxy/(meth)acrylate containing compounds containing both epoxy and (meth)acrylate functionality can also be utilized, and obtained from reaction of multi-epoxide containing compound with one or less equivalent of (meth)acrylic acid, or reaction of hydroxyl containing (meth)acrylate with epichlorohydrin. Commercially available epoxy/methacrylate include 3,4-epoxy-cyclohexyl methyl methacrylate. Additional resin materials that can be used in some cases include bifunctional epoxy/acrylate material, and epoxy/acrylate oligomeric material made from the reaction product of a multi-epoxide containing compound and hydroxy (meth)acrylate.

Various other modifications, adaptations, and alternative designs are of course possible in light of the above teachings. For example, features including brackets disclosed in U.S. Pub. No. 2014/0120491 A1 to Khoshnevis et al., hereby incorporated by reference in its entirety, can be utilized or modified or use with embodiments as disclosed herein. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “transferring an orthodontic bracket” includes “instructing the transferring of an orthodontic bracket.” The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

1. (canceled)

2. A 3-D printed indirect bonding tray for placing orthodontic brackets, the 3-D printed indirect bonding tray comprising:
a first resin material; and
a second resin material for one or more tray markings, wherein the second resin material is encapsulated within the first resin material.

3. The 3-D printed indirect bonding tray of claim 2, wherein the first resin material and the second resin material are different colors.

4. The 3-D printed indirect bonding tray of claim 2, wherein the first resin material is clear and the second resin material is opaque.

5. The 3-D printed indirect bonding tray of claim 2, wherein the first resin material is translucent and the second resin material is opaque.

6. The 3-D printed indirect bonding tray of claim 2, wherein the first resin material and the second resin material comprise different durometers.

7. The 3-D printed indirect bonding tray of claim 2, wherein the first resin material is more flexible than the second resin material.

8. The 3-D printed indirect bonding tray of claim 2, wherein the second resin material is more rigid than the first resin material.

9. The 3-D printed indirect bonding tray of claim 2, further comprising a flash release configured to channel away excess adhesive applied to the orthodontic brackets during a bonding process.

10. The 3-D printed indirect bonding tray of claim 2, wherein the first resin material is biocompatible and the second resin material is non-biocompatible.

11. The 3-D printed indirect bonding tray of claim 2, further comprising one or more perforations to segment the 3-D printed indirect bonding tray.

12. The 3-D printed indirect bonding tray of claim 11, wherein one of the one or more perforations are disposed between each tooth well.

13. The 3-D printed indirect bonding tray of claim 2, further comprising one or more tabs indicating patient identifying information.

14. The 3-D printed indirect bonding tray of claim 13, wherein the one or more tabs are detachable.

15. The 3-D printed indirect bonding tray of claim 13, wherein the one or more tabs extend lingually inward.

16. The 3-D printed indirect bonding tray of claim 2, further comprising one or more handles.

17. The 3-D printed indirect bonding tray of claim 2, further comprising a plurality of separate tray segments.

18. The 3-D printed indirect bonding tray of claim 17, wherein each of the plurality of separate tray segments comprises a tab indicating patient identifying information.

19. The 3-D printed indirect bonding tray of claim 2, wherein the one or more tray markings comprise a midline marking.

20. The 3-D printed indirect bonding tray of claim 2, wherein the one or more tray markings comprise an alphanumeric tooth marking.

21. A 3-D printed indirect bonding tray for placing orthodontic brackets, the 3-D printed indirect bonding tray comprising:
a first resin material; and
a second resin material encapsulated within the first resin material.
